(19) United States
(12) Patent Application Publication
(10) Pub. No.: US 2026/0088925 A1
(43) Pub. Date: Mar. 26, 2026

(54) Compensation of PTP network asymmetry for APTS clocks during PTP disruption

(71) Applicant: Ciena Corporation, Hanover, MD (US)

(72) Inventors: Ankur Saxena, Bangalore (IN); Vineet Kumar Garg, Gurugram (IN)

(73) Assignee: Ciena Corporation, Hanover, MD (US)

(21) Appl. No.: 18/937,556

(22) Filed: Nov. 5, 2024

(30) Foreign Application Priority Data
Sep. 23, 2024 (IN) 202411071772

(51) Int. Cl. H04J 3/06

(52) U.S. Cl. CPC H04J 3/0667; H04J 3/0641

(57) ABSTRACT

A method for compensating Precision Time Protocol (PTP) network asymmetry for Assisted Partial Timing Support (APTS) clocks during PTP disruptions in a network includes, while a local time reference is connected to the APTS node and while PTP is operational, determining a current network path to a PTP Grandmaster connected to the APTS node, determining asymmetry between the APTS node and the PTP Grandmaster, and storing the determined asymmetry based on the current network path; and during a failure of the local time reference and subsequent to recovery of a PTP disruption between the APTS node and the PTP Grandmaster, utilizing a corresponding stored determined asymmetry on a recovered path between the APTS node and either the PTP Grandmaster or another PTP Grandmaster.

### FIELD OF THE DISCLOSURE

The present disclosure relates generally to networking. More particularly, the present disclosure relates to systems and methods for compensating Precision Time Protocol (PTP) network asymmetry for Assisted Partial Timing Support (APTS) clocks during PTP disruptions.

### BACKGROUND OF THE DISCLOSURE

Precision Time Protocol (PTP) is a network protocol used to synchronize clocks across devices in a network, ensuring precise time alignment. PTP works by exchanging timing messages between a master clock and slave clocks, allowing devices to adjust their internal clocks with high precision, typically within nanoseconds. This synchronization is essential for applications requiring time-sensitive data transmission and coordination, especially in Fifth generation (5G) network applications. PTP is described in the IEEE 1588 standards, such as “IEEE Standard for a Precision Clock Synchronization Protocol for Networked Measurement and Control Systems,” in IEEE Std 1588-2019 (Revision of IEEE Std 1588-2008), 16 Jun. 2020, the contents of which are incorporated by reference in their entirety. This is generally referred to as IEEE 1588v2.x.

APTS (Assisted Partial Timing Support) is designed to enhance the precision of time and phase synchronization over packet networks. APTS operates by leveraging partial timing support from the network, combined with an accurate local oscillator or GNSS (Global Navigation Satellite System) receiver, to maintain synchronization. This approach is particularly beneficial in scenarios where full timing support across the network is not feasible or available. APTS enables the delivery of accurate time and phase information by correcting any timing errors using assistance from a local, stable reference, ensuring high-quality synchronization for applications like mobile backhaul and 5G networks. APTS is described in ITU-T Recommendation G.8275/Y.1369, “Architecture and requirements for packet-based time and phase distribution,” 01/24, ITU-T Recommendation G.8275.2/Y.1369.2, “Precision time protocol telecom profile for phase/time synchronization with partial timing support from the network,” 11/2022, and ITU Recommendation G.8273.4/Y.1368.4, “Timing characteristics of telecom boundary clocks and telecom time slave clocks for use with partial timing support from the network,” 03/20, the contents of each are incorporated by reference in their entirety.

While APTS adds resiliency and redundancy to the network, there are scenarios where disruptions can occur. Network asymmetry is calculated when a PTP connection is present while locked to GNSS. An example disruption includes, if PTP takes over and GNSS is lost, then there is no clear way to determine compensation to be applied if there is a temporary loss of the PTP connection.

### BRIEF SUMMARY OF THE DISCLOSURE

The present disclosure relates to systems and methods for compensating Precision Time Protocol (PTP) network asymmetry for Assisted Partial Timing Support (APTS) clocks during PTP disruptions. The present disclosure increasing the resiliency of APTS with an approach to apply asymmetry compensation in cases where GNSS is lost and where a PTP connection temporarily is down. This includes storing network paths used to reach selected PTP master n APTS asymmetry calculations. When the PTP connection is restored and when GNSS is already lost, the previously calculated asymmetry is applied to PTP calculations based on the previously stored network path. Advantageously, the present disclosure increases robustness of timing, specifically asymmetry compensation, in networks, and is particularly important in 5G applications.

In various embodiments, the present disclosure includes a method having steps, an apparatus such as a node, processing device, network element, etc. with circuitry configured to implement the steps, and a non-transitory computer-readable medium storing instructions that, when executed, cause circuitry to implement the steps. The steps are for compensating Precision Time Protocol (PTP) network asymmetry for Assisted Partial Timing Support (APTS) clocks during PTP disruptions. The steps include, while a local time reference is connected to the APTS node and while PTP is operational, determining a current network path to a PTP Grandmaster connected to the APTS node, determining asymmetry between the APTS node and the PTP Grandmaster, and storing the determined asymmetry based on the current network path; and during a failure of the local time reference and subsequent to recovery of a PTP disruption between the APTS node and the PTP Grandmaster, utilizing a corresponding stored determined asymmetry on a recovered path between the APTS node and either the PTP Grandmaster or another PTP Grandmaster.

The local time reference can be from a Global Navigation Satellite System (GNSS) receiver. The PTP disruption can be temporary while the failure of the local time reference remains, such that the stored determined asymmetry is utilized on the recovered path. The recovered path can be a new path subsequent to the recovery. The APTS node can include a Telecom Boundary Clock (T-BC) and the PTP Grandmaster includes a Telecom Grandmaster (T-GM). The network can include a plurality of T-GMs, each having one or more network paths to the APTS node. The steps can further include continually updating the stored determined asymmetry based on any new paths and any new measurements on existing paths. The determining asymmetry can be based on references from the local time reference and in PTP packets, and differences therebetween. The APTS node and the PTP Grandmaster can each be integrated in or locally connected to a corresponding network element in the network.

### BRIEF DESCRIPTION OF THE DRAWINGS

The present disclosure is detailed through various drawings, where like components or steps are indicated by identical reference numbers for clarity and consistency.

FIG. 1 illustrates a network diagram for illustrating timing distribution in a network which includes two PTP masters, T-GM-1 12 and T-GM-2.

FIG. 2 illustrates a flowchart of a process which provides resiliency to PTP disruptions when GNSS is down.

FIG. 3 illustrates a block diagram of a network element, depicted in a simplified functional format.

FIG. 4 illustrates a block diagram of an example processing device.

FIG. 5 illustrates a flowchart of a process for compensating Precision Time Protocol (PTP) network asymmetry for Assisted Partial Timing Support (APTS) clocks during PTP disruptions.

### DETAILED DESCRIPTION OF THE DISCLOSURE

Again, the present disclosure relates to systems and methods for compensating Precision Time Protocol (PTP) network asymmetry for Assisted Partial Timing Support (APTS) clocks during PTP disruptions. 5G applications are timing sensitive in nature and need high accuracy, a great attention is given to the latency and delay present in the network. This may include Transport network propagation delay, network timing and synchronization error, and distributions error before end applications. PTP defined by IEE-1588 is used to deliver precise time across the network. Any packet network may have events related to network re-routes, link failover and restoration, and packet path change overs due to various reasons, and these events can impact PTP packet delays on both the transmit and receive path.

Time delay asymmetry in packet networks occurs when the time it takes for packets to travel from a sender to a receiver (forward path) differs from the time it takes for packets to return from the receiver to the sender (reverse path). This asymmetry can be caused by various factors, such as differing routing paths, varying queuing delays, or unequal processing times at network devices. As a result, the perceived timing information can be skewed, leading to inaccuracies in time synchronization.

PTP is used to synchronize clocks across a packet network. PTP works by exchanging timing messages between a master clock and one or more slave clocks, each at network nodes or network elements, i.e., switches, routers, etc. These messages include timestamps that allow the slave clocks to adjust their time to match the master clock. However, PTP assumes symmetric delays on the forward and reverse paths. In the presence of delay asymmetry, the synchronization accuracy of PTP is compromised, as the timing calculations are based on the assumption that the delays are equal in both directions.

APTS comes into play as a method to improve synchronization accuracy in networks where full timing support (e.g., having a PTP grandmaster in every segment) is not available or where asymmetries are present. APTS leverages a combination of partial timing support from the network and a highly accurate local reference, such as a GNSS receiver or an atomic clock. By comparing the timing information received via PTP with the local reference, APTS can detect and correct timing errors, including those caused by delay asymmetry.

Delay asymmetry compensation is achieved by estimating or measuring the asymmetry and adjusting the timing calculations accordingly. In networks using APTS, this involves comparing the time received from the PTP messages with the local reference time and calculating the discrepancy caused by the asymmetric delay. Once this discrepancy is known, it can be compensated by adjusting the slave clock to correct for the asymmetry, thereby restoring synchronization accuracy. Some advanced implementations may involve network monitoring tools that measure and report the degree of asymmetry in real-time, allowing for dynamic compensation. By addressing delay asymmetry, especially when combined with APTS, networks can maintain high precision in time synchronization, even in challenging environments where full timing support or symmetrical delays are not guaranteed.

ITU-T has defined G.8275.2 for Partial Timing Support and Assisted Partial Timing Support (APTS) profiles. G.8275.2 APTS network allows network operator to use a Local time reference (e.g., GNSS such as Global Positioning Satellite (GPS)) and PTP as backup together to identify transport network asymmetry exists on the PTP path, an APTS node may use this asymmetry to compensate the network error while switching from GNSS to PTP source on GNSS failover.

If due to a network event, a PTP connection is lost while the GNSS is also failed, i.e., the local time reference, the previously calculated asymmetry may not be directly applicable when the PTP connection is restored. This may be because the PTP connection is following a new network path upon restoration which has different asymmetry values. Using a previously calibrated asymmetry value in PTP calculations in such case can lead to time error in clock recovered through PTP. That is, the previously calibrated asymmetry value is for a different network path and its use is unreliable if the restored network path has a different symmetry value, leading to significant time errors which can impact or even cause disruptions in the end applications.

PTP connections can experience disruptions due to various factors such as network congestion, packet loss, delay asymmetry, network reconfigurations, hardware and software issues, environmental factors, and security threats. These disruptions can affect the accuracy of time synchronization, especially in complex or poorly managed networks. While PTP is designed to be robust, its effectiveness can be compromised by these challenges. To mitigate disruptions, network operators often employ best practices, redundancy, and technologies like APTS to maintain precise time synchronization.

Further, GNSS connections can be disrupted by various factors, including signal obstruction from buildings or natural features, atmospheric conditions like solar storms, and multipath interference where signals bounce off surfaces. Urban environments are particularly prone to frequent disruptions due to these issues. Intentional jamming and spoofing, although less common, pose significant risks, as do receiver malfunctions and high solar activity. The frequency of GNSS disruptions varies, with open areas experiencing fewer issues, while urban settings and regions with high solar activity or intentional interference can face disruptions more frequently, ranging from occasional to persistent.

Of note, the objective is to have a same time delay on both the transmit and receive path, which is critical for some applications including 5G which are sensitive to latency and timing discrepancies. As there are possibilities for disruptions in PTP and GNSS at the same time, there needs to be a solution that maintains timing including an ability to reuse existing delay asymmetry values upon PTP recovery. The current approach does not offer a solution.

The present disclosure includes an approach to maintain and reuse a previously calculated asymmetry for a PTP master (referred to as a Telecom-Grandmaster (T-GM)) via a PTP path against GNSS. A T-GM is a specialized, high-precision clock device that serves as the primary time source in telecommunications networks. It distributes accurate time and phase information to downstream devices, ensuring synchronized operations critical for services like 4G/5G mobile networks. T-GMs are designed to meet stringent telecom requirements, incorporating high-stability reference clocks, supporting telecom-specific PTP profiles, and offering redundancy and resilience features to maintain synchronization even during disruptions. This ensures reliable timing across the network, essential for functions like time-division duplexing and carrier aggregation.

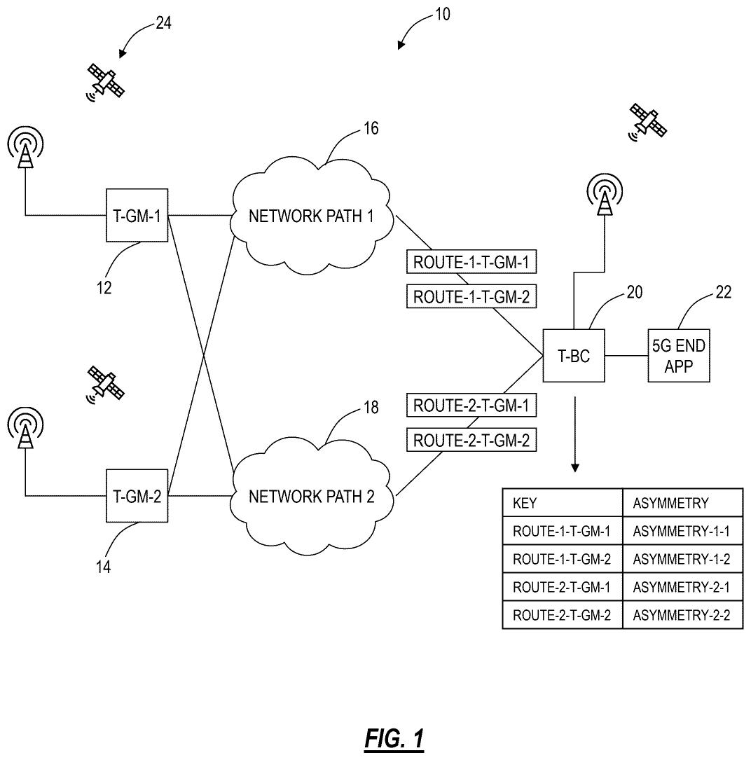

FIG. 1 illustrates a network diagram for illustrating timing distribution in a network 10 which includes two PTP masters, T-GM-1 12 and T-GM-2 14. The network 10 is a packet network including network elements such as switches, routers, etc. which are omitted for simplicity of illustration. The PTP T-GM-1 12, T-GM-2 14 can be reachable via multiple nodes/paths (illustrated in FIG. 1 as network path 1 16, network path 2 18) in the network 10. Of course, a practical embodiment can include more than two network paths 16, 18; these two network paths 16, 18 are presented for illustration purposes. A key point is each network path 16, 18 can have a different set of nodes and a different amount of asymmetry.

The network 10 also includes a Telecom Boundary Clock (T-BC) 20. The T-BC 20 is a network device that enhances time synchronization accuracy by acting as an intermediary between the Grandmaster T-GM-1 12, T-GM-2 12, 14 and downstream devices, such as a 5G end app 22. It receives timing information from the Grandmaster T-GM-1 12, T-GM-2 12, 14, synchronizes its own clock, and then distributes corrected timing to other network elements, mitigating network delays and errors. The T-BC 20 is useful in large or complex networks where direct synchronization from the Grandmaster T-GM-1 12, T-GM-2 12, 14 is impractical. They support telecom-specific PTP profiles to ensure precise timing for critical applications like mobile backhaul and 5G networks.

Typically, the Grandmasters T-GM-1 12, T-GM-2 12, 14 are centrally located, typically at a core network site or data center, and connected to the primary routing infrastructure to distribute accurate timing across the network. The T-BC 20 is positioned at various levels closer to the network edge, such as in access networks or aggregation points, where they correct timing errors and relay precise timing to downstream devices. Both T-GMs and T-BCs can be integrated into or connected to network elements like routers and switches, ensuring reliable synchronization across the network 10.

Additionally, the network 10 includes GNSS 24 connections to each of the Grandmasters T-GM-1 12, T-GM-2 12, 14 and the T-BC 20. GNSS is used for timing distribution in the network 10, providing a highly accurate and reliable source of time and frequency synchronization. GNSS satellites transmit precise time signals from atomic clocks on board, which can be received by GNSS receivers on the ground. These receivers use the signals to synchronize local clocks to the Coordinated Universal Time (UTC), providing timing accuracy within nanoseconds. GNSS-based timing is often integrated into Telecom Grandmasters (T-GM) and other network elements to ensure that the entire network operates in perfect sync, even over large geographic areas.

Again, for illustration purposes, FIG. 1 illustrates two network paths 16, 18, and the Grandmasters T-GM-1 12, T-GM-2 12, 14 can be reachable via multiple nodes/paths in a packet network and each path have a set of nodes and asymmetry.

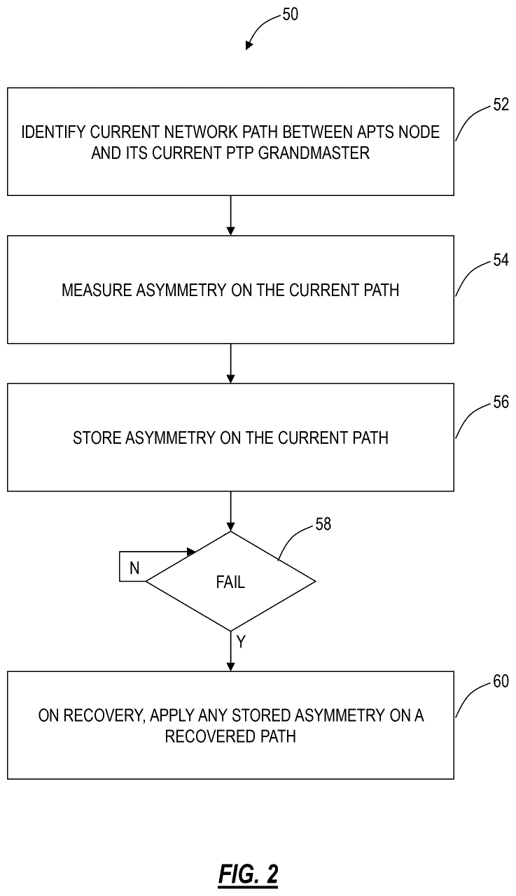

FIG. 2 illustrates a flowchart of a process 50 which provides resiliency to PTP disruptions when GNSS is down. The process 50 contemplates implementation at the T-BC 20, including at a corresponding network element associated with the T-BC 20. The process 50 includes identifying a current network path between the APTS node, i.e., the T-BC 20, and its current PTP Grandmaster, e.g., the Grandmasters T-GM-1 12, T-GM-2 12, 14 (step 52). In the example of FIG. 1, there are four possible paths, namely:

| ROUTE | DESCRIPTION |
|---|---|
| ROUTE-1-T-GM-1 | Between the T-BC 20 and the |
| | T-GM-1 via the network path 16 |
| ROUTE-1-T-GM-2 | Between the T-BC 20 and the |
| | T-GM-2 via the network path 16 |
| ROUTE-2-T-GM-1 | Between the T-BC 20 and the |
| | T-GM-1 via the network path 18 |
| ROUTE-2-T-GM-2 | Between the T-BC 20 and the |
| | T-GM-2 via the network path 18 |

The approach of finding the current network path can be implementation specific or can be based on existing technologies like Traceroute for example or a network controller can provide that information to the APTS node as well.

Next, as part of normal operation, the process 50 includes measuring the asymmetry on the current path (step 54). To measure asymmetry, one can use a method where the timing information from the PTP system is compared against the highly accurate reference provided by a GNSS receiver. The GNSS serves as a stable and precise time source. By comparing the time received via PTP with the GNSS-provided time, any discrepancies caused by delay asymmetry in the PTP network can be identified. The difference between the two-timing sources indicates the level of asymmetry. In APTS systems, this information is used to adjust the timing offset in the PTP slaves, compensating for the asymmetry and ensuring accurate synchronization. Continuous monitoring allows for real-time detection and correction of any asymmetry, maintaining high precision in timing distribution across the network.

Next, the process 50 includes storing the measured asymmetry on the current path (step 56). Once Asymmetry is identified, the APTS node stores that value against PTP master Clock Identity and current network path identifier, the network path identifier is an ID to identify the path via current T-GM is reachable. For example:

| KEY | ASYMMETRY |
|---|---|
| ROUTE-1-T-GM-1 | ASYMMETRY-1-1 |
| ROUTE-1-T-GM-2 | ASYMMETRY-1-2 |
| ROUTE-2-T-GM-1 | ASYMMETRY-2-1 |
| ROUTE-2-T-GM-2 | ASYMMETRY-2-2 |

In the case of a failure (step 58), the APTS node applies the asymmetry on a recovered path (step 60). This can be based on the stored values of asymmetry. Specifically, while switching to a backup PTP asymmetry can be applied as usual, after that whenever there is (1) a temporary network failure in PTP, (2) the GNSS is still failed, and (3) a T-GM is reachable again after recovery, if the APTS node has seen the T-GM before and has the asymmetry calculated against the current path (it may query to controller or use any proprietary method to fetch the packet path) then it applies the same old asymmetry before locking back to that T-GM.

In FIG. 1, over a period of time, it is possible for an APTS clock (T-BC 20) to learn and store network asymmetry over different paths 16, 18 in network 10 to same clock source and use it to improve clock synchronization performance based on path used to connect with PTP clock source.

APTS calculates asymmetry on a continuous basis while the system is locked to GNSS and uses last known compensation at time it needs to start using PTP which was used for asymmetry compensation in case of GNSS failure. This asymmetry can be a combination of fixed asymmetry in network (e.g., due to fiber length or physical aspects) and variable asymmetry caused due to different Packet Delay Variation (PDV) in forward and reverse direction. Overall PDV on network is filtered out and PTP algorithm determines the floor value of delay in each direction. The difference between these leads to calculation of this compensation value. Even when PTP is connected, the compensation value changes periodically and there is no guarantee that this value will be exactly accurate at time of GNSS failure. However, this value provides a starting phase offset between GNSS and PTP source using which PTP algorithm can recover precise clock in absence of GNSS. After this value has been applied, PDV is still present and PTP algorithm continues to filter the noise to determine the fixed floor of delays which needs to be taken into account for clock recovery.

This approach is meant to improve APTS behavior in the cases where asymmetry remains nearly same (within few 100 s of nanoseconds for telecom use cases) while using the same path when PTP is restored. In the worst-case, asymmetry in network is completely different although using same path after restoration. However, that condition would be a rare condition but one which can happen even without the temporary failure of PTP. Even in this worst-case scenario, this approach will help PTP start off with a known asymmetry and determine a more accurate value as it start calculations again on restoration of PTP.

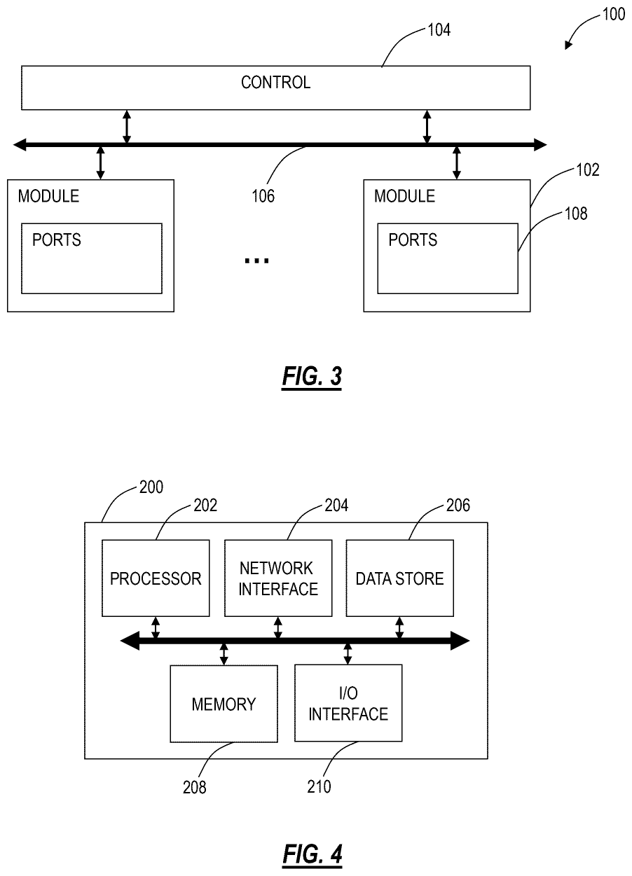

FIG. 3 illustrates a block diagram of a network element 100, depicted in a simplified functional format. It is important to note that a more practical design of this router would likely include additional components and processing logic to accommodate standard operating features, which are not detailed here. The network element 100 may represent any network element operable in a network using optical and packet protocols, and includes various interconnected modules, such as modules 102 and 104, via an interface 106. These modules, also known as blades or line cards, are typically mounted on the chassis of a data switching device. Each module can house numerous electronic or optical devices on a circuit board, complete with various interconnects, including interfaces to the chassis itself.

Specifically, the diagram illustrates two types of modules: line modules 102, which feature multiple Ethernet ports for external connections, and a control module 104. The line modules facilitate data traffic switching between ports via a switching fabric, integrated across the modules, potentially centralized in a separate unit or module, as well as a combination. This switching fabric includes hardware, software, and firmware that routes incoming data to the appropriate port. The control module 104 is equipped with a microprocessor, memory, software, and a network interface to manage operations such as configuration and monitoring of the network element 100. It may also communicate with external network management systems or databases that handle provisioning and operational data.

Lastly, while FIG. 3 provides a basic view, those skilled in the art will understand that the network element 100 could include additional components or be configured differently, such as in a distributed arrangement or as an integrated, rack-mounted unit (often referred to as a “pizza-box” configuration). This depiction in FIG. 3 is intended to convey functional aspects, with actual hardware implementations varying widely.

The network element 100 can include the Grandmasters T-GM-1 12, T-GM-2 12, 14 and the T-BC 20 integrated therein or connected thereto.

FIG. 4 illustrates a block diagram of an example processing device 200. The processing device 200 may be integrated within the network element 100 or function as a standalone unit connected to the network element 100. It may also be known as an apparatus, a control module, shelf controller, shelf processor, or system controller. The core of the processing device 200 is a processing unit 202, a hardware unit that runs software instructions. The processing unit 202 could be one or more custom or commercially available processors, i.e., one or more processors. During operation, the processing unit 202 executes software from memory, manages data communication with the memory, and controls the processing device 200 operations based on the software.

The processing device 200 also features several components connected to the processing unit 202: a network interface 204, a data store 206, memory 208, and an I/O interface 210. The network interface 204, possibly an Ethernet device, allows the processing device 200 to communicate over a data network and includes necessary connections for address, control, and data communication. The data store 206 stores various types of data such as telemetry data, OAM&P data, etc., and may include both volatile (e.g., RAM) and nonvolatile (e.g., ROM, hard drives) memory elements. Similarly, the memory 208 includes volatile and nonvolatile storage media, potentially employing a distributed architecture where components are located remotely but accessible by the processing unit 202. The I/O interface facilitates communication between processing device 200 and external devices.

Those skilled in the art will recognize that the various embodiments may include processing circuitry of various types, including the processing unit 202 in the processing device 200. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

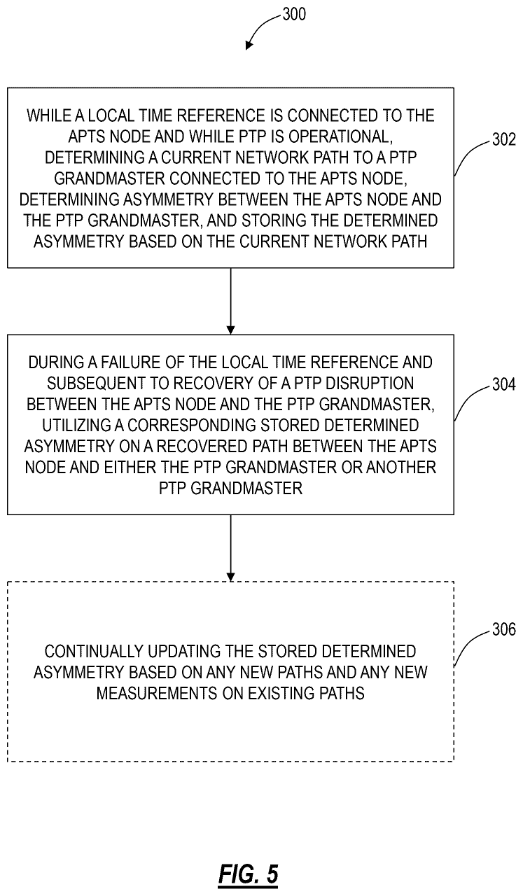

FIG. 5 illustrates a flowchart of a process 300 for compensating Precision Time Protocol (PTP) network asymmetry for Assisted Partial Timing Support (APTS) clocks during PTP disruptions. The process 300 contemplates implementation as a method having steps, via circuitry configured to implement the steps, and as a non-transitory computer-readable medium storing instructions that, when executed, cause one or more processors to implement the steps. The circuitry can be part of the network element 100 or the processing device 200.

The process 300 includes, while a local time reference is connected to the APTS node and while PTP is operational, determining a current network path to a PTP Grandmaster connected to the APTS node, determining asymmetry between the APTS node and the PTP Grandmaster, and storing the determined asymmetry based on the current network path (step 302); and, during a failure of the local time reference and subsequent to recovery of a PTP disruption between the APTS node and the PTP Grandmaster, utilizing a corresponding stored determined asymmetry on a recovered path between the APTS node and either the PTP Grandmaster or another PTP Grandmaster (step 304).

In an embodiment, the local time reference is from a Global Navigation Satellite System (GNSS) receiver. The PTP disruption can be temporary while the failure of the local time reference remains, such that the stored determined asymmetry is utilized on the recovered path. The recovered path can be a new path subsequent to the recovery. The APTS node includes a Telecom Boundary Clock (T-BC) and the PTP Grandmaster includes a Telecom Grandmaster (T-GM). The network can include a plurality of T-GMs, each having one or more network paths to the APTS node.

The process 300 can further include continually updating the stored determined asymmetry based on any new paths and any new measurements on existing paths (step 306). The determining asymmetry is based on references from the local time reference and in PTP packets, and differences therebetween. In an embodiment, the APTS node and the PTP Grandmaster are each integrated in or locally connected to a corresponding network element in the network.

As used herein, including in the claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing are contemplated. Furthermore, the separation of system components described should not be interpreted as mandatory for all implementations, as the program components and systems can be integrated into a single software product or distributed across multiple software products.

What is claimed is:

1. A method for compensating Precision Time Protocol (PTP) network asymmetry for Assisted Partial Timing Support (APTS) clocks during PTP disruptions, the method implemented at an APTS node in a network and the method comprising steps of:
while a local time reference is connected to the APTS node and while PTP is operational, determining a current network path to a PTP Grandmaster connected to the APTS node, determining asymmetry between the APTS node and the PTP Grandmaster, and storing the determined asymmetry based on the current network path; and
during a failure of the local time reference and subsequent to recovery of a PTP disruption between the APTS node and the PTP Grandmaster, utilizing a corresponding stored determined asymmetry on a recovered path between the APTS node and either the PTP Grandmaster or another PTP Grandmaster.

2. The method of claim 1, wherein the local time reference is from a Global Navigation Satellite System (GNSS) receiver.

3. The method of claim 1, wherein the PTP disruption is temporary while the failure of the local time reference remains, such that the stored determined asymmetry is utilized on the recovered path.

4. The method of claim 1, wherein the recovered path is a new path subsequent to the recovery.

5. The method of claim 1, wherein the APTS node includes a Telecom Boundary Clock (T-BC) and the PTP Grandmaster includes a Telecom Grandmaster (T-GM).

6. The method of claim 5, wherein the network includes a plurality of T-GMs, each having one or more network paths to the APTS node.

7. The method of claim 1, wherein the steps further include continually updating the stored determined asymmetry based on any new paths and any new measurements on existing paths.

8. The method of claim 1, wherein the determining asymmetry is based on references from the local time reference and in PTP packets, and differences therebetween.

9. The method of claim 1, wherein the APTS node and the PTP Grandmaster are each integrated in or locally connected to a corresponding network element in the network.

10. An Assisted Partial Timing Support (APTS) node in a network configured to compensate Precision Time Protocol (PTP) network asymmetry during PTP disruptions, the APTS node comprising circuitry configured to:
while a local time reference is connected to the APTS node and while PTP is operational, determine a current network path to a PTP Grandmaster connected to the APTS node, determine asymmetry between the APTS node and the PTP Grandmaster, and store the determined asymmetry based on the current network path, and
during a failure of the local time reference and subsequent to recovery of a PTP disruption between the APTS node and the PTP Grandmaster, utilize a corresponding stored determined asymmetry on a recovered path between the APTS node and either the PTP Grandmaster or another PTP Grandmaster.

11. The APTS node of claim 10, wherein the local time reference is from a Global Navigation Satellite System (GNSS) receiver.

12. The APTS node of claim 10, wherein the PTP disruption is temporary while the failure of the local time reference remains, such that the stored determined asymmetry is utilized on the recovered path.

13. The APTS node of claim 10, wherein the recovered path is a new path subsequent to the recovery.

14. The APTS node of claim 10, wherein the APTS node includes a Telecom Boundary Clock (T-BC) and the PTP Grandmaster includes a Telecom Grandmaster (T-GM).

15. The APTS node of claim 14, wherein the network includes a plurality of T-GMs, each having one or more network paths to the APTS node.

16. The APTS node of claim 10, wherein the circuitry is further configured to continually update the stored determined asymmetry based on any new paths and any new measurements on existing paths.

17. The APTS node of claim 10, wherein the asymmetry is determined based on references from the local time reference and in PTP packets, and differences therebetween.

18. The APTS node of claim 10, wherein the APTS node and the PTP Grandmaster are each integrated in or locally connected to a corresponding network element in the network.

19. A non-transitory computer-readable medium comprising instructions for compensating Precision Time Protocol (PTP) network asymmetry for Assisted Partial Timing Support (APTS) clocks during PTP disruptions, the instructions are implemented at an APTS node in a network and, when executed, the instructions cause circuitry to perform steps of:
while a local time reference is connected to the APTS node and while PTP is operational, determining a current network path to a PTP Grandmaster connected to the APTS node, determining asymmetry between the APTS node and the PTP Grandmaster, and storing the determined asymmetry based on the current network path; and
during a failure of the local time reference and subsequent to recovery of a PTP disruption between the APTS node and the PTP Grandmaster, utilizing a corresponding stored determined asymmetry on a recovered path between the APTS node and either the PTP Grandmaster or another PTP Grandmaster.

20. The non-transitory computer-readable medium of claim 19, wherein the PTP disruption is temporary while the failure of the local time reference remains, such that the stored determined asymmetry is utilized on the recovered path.
